(19) United States
(12) Patent Application Publication
(10) Pub. No.: US 2025/0243028 A1
(43) Pub. Date: Jul. 31, 2025

(54) IMAGE FORMING APPARATUS

(71) Applicant: Takeshi SAKASHITA, Kanagawa (JP)

(72) Inventor: Takeshi SAKASHITA, Kanagawa (JP)

(21) Appl. No.: 19/019,591

(22) Filed: Jan. 14, 2025

(30) Foreign Application Priority Data
Jan. 31, 2024 (JP) 2024-012670

(51) Int. Cl. B65H 29/24; B65H 31/02

(52) U.S. Cl. CPC B65H 29/245; B65H 31/02; B65H 2301/4461

(57) ABSTRACT

An image forming apparatus includes an image forming device, a sheet stacking portion, a side projecting portion, a rear projecting portion, and a blower. The sheet stacking portion is disposed above the image forming device to stack sheets after image forming. The side projecting portion protrudes upward from a lateral end of the image forming device and includes a sheet ejection passage to convey the sheet after image forming and a sheet ejection port to eject the sheet toward the sheet stacking portion. The rear projecting portion protrudes upward from a rear end of the image forming device and forms a space together with the side projecting portion. The blower is disposed in the space to face the rear projecting portion, takes in air from a side facing the rear projecting portion, and exhausts the air from the sheet ejection port toward the sheet ejected toward the sheet stacking portion.

### CROSS-REFERENCE TO RELATED APPLICATION

This patent application is based on and claims priority pursuant to 35 U.S.C. § 119(a) to Japanese Patent Application No. 2024-012670, filed on Jan. 31, 2024, in the Japan Patent Office, the entire disclosure of which is hereby incorporated by reference herein.

### BACKGROUND

### Technical Field

Embodiments of the present disclosure relate to an image forming apparatus such as a copying machine, a printer, a facsimile machine, or a multifunction peripheral thereof.

### Related Art

An image forming apparatus such as a copier or a printer is known in which a sheet stacking portion is formed above an image forming device to be surrounded by a plurality of walls (e.g., a side projecting portion and a rear projecting portion). Specifically, sheets on which images have been formed in the image forming device are ejected from a sheet ejection port via a sheet ejection passage of the side projecting portion that protrudes upward from a side of the image forming device, and then are stacked on the sheet stacking portion.

### SUMMARY

In an embodiment of the present disclosure, an image forming apparatus includes an image forming device, a sheet stacking portion, a side projecting portion, a rear projecting portion, and a blower. The image forming device forms an image on a sheet. The sheet stacking portion is disposed above the image forming device to stack the sheet on which the image has been formed by the image forming device. The side projecting portion protrudes upward from a lateral end of the image forming device, is adjacent to the sheet stacking portion, and includes a sheet ejection passage and a sheet ejection port. The sheet ejection passage conveys the sheet on which the image has been formed by the image forming device. The sheet ejection port ejects the sheet toward the sheet stacking portion. The rear projecting portion protrudes upward from a rear end of the image forming device and is adjacent to the sheet stacking portion to form a space together with the side projecting portion. The blower is disposed in the space to face the rear projecting portion on a front side of the rear projecting portion, takes in air from a side facing the rear projecting portion, and exhausts the air from the sheet ejection port toward the sheet ejected toward the sheet stacking portion.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an image forming apparatus according to an embodiment of the present disclosure;

FIG. 2 is a perspective view of the image forming apparatus of FIG. 1;

FIG. 3 is a diagram illustrating a sheet stacking portion and its vicinity;

FIG. 4 is a side view of an in-body space of an image forming apparatus, viewed from the left side of the image forming apparatus;

FIG. 5 is a diagram illustrating the flow of air in a blower;

FIG. 6 is a perspective view of a second sheet stacking portion and a blower as viewed from obliquely below; and

FIG. 7 is a perspective view of the second sheet stacking portion and the blower of FIG. 6 as viewed from obliquely above.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. Like reference signs are assigned to like elements or components and descriptions of those elements or components may be simplified or omitted. As used herein, the singular forms “a,” “an,” and “the” are intended to include the plural forms as well, unless the context clearly indicates otherwise.

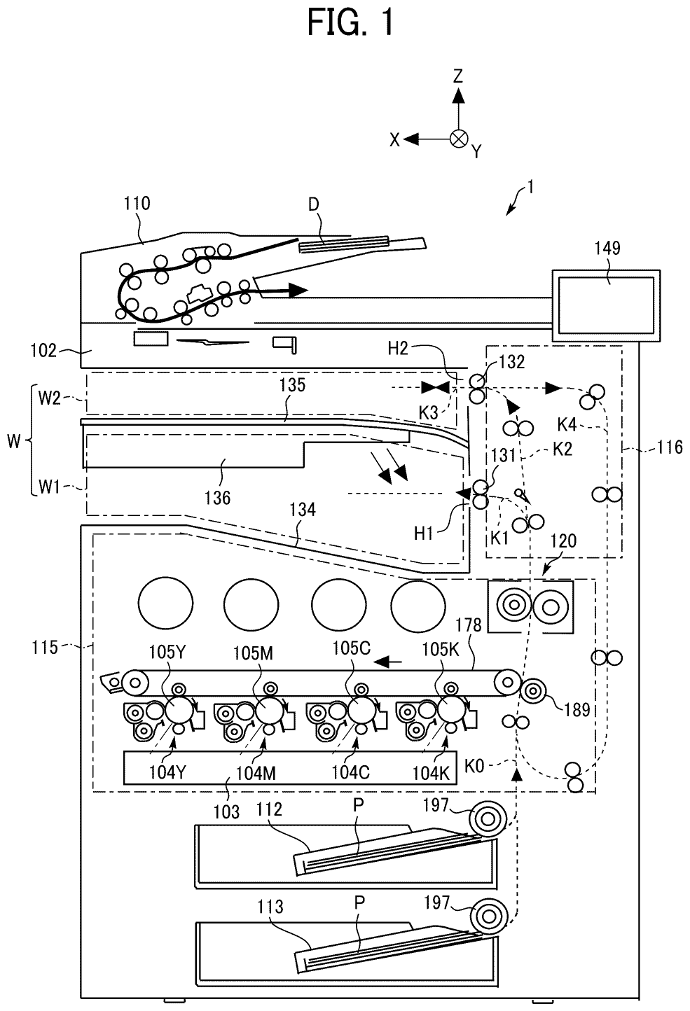

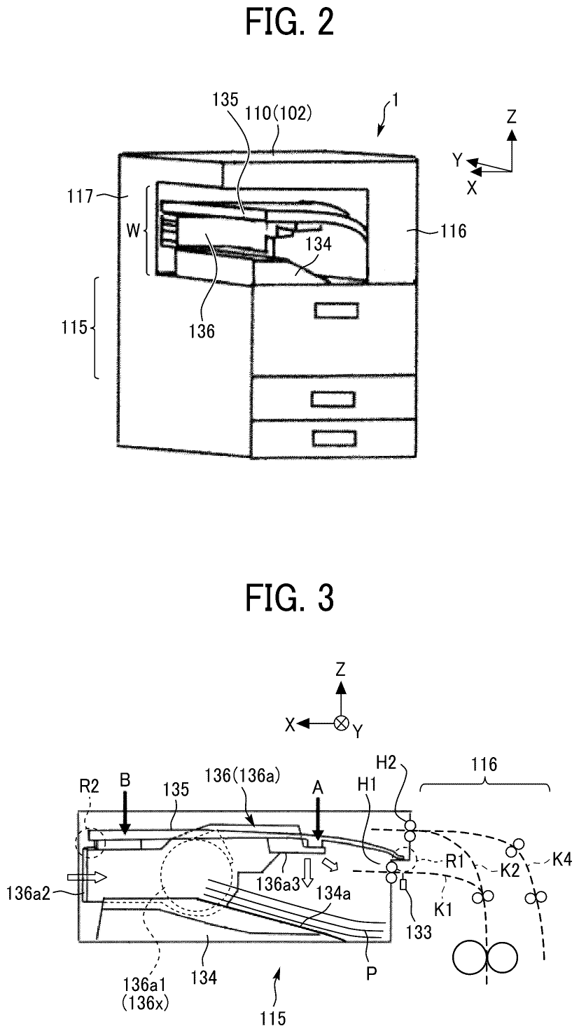

With reference to FIGS. 1 and 2, a description is given of a configuration and operation of an image forming apparatus 1 according to the present embodiment. As illustrated in FIGS. 1 and 2, the image forming apparatus 1 according to the present embodiment has a space W (in-body space) surrounded by a side projecting portion 116 (also serving as a side wall) and a rear projecting portion 117 (also serving as a rear wall) below a document feeder 110 (and a document reading device 102) and above an image forming device 115. The space W (in-body space) is a space in which sheets P (sheets P after image formation (after printing)) ejected from the image forming apparatus 1 can be ejected and stacked, and is also a space in which the ejected and stacked sheets P can be taken out.

The in-body space W has a first space W1 and a second space W2. The second space W2 separated by a second sheet stacking portion 135 (a reverse tray) is above the first space W1. The first space W1 is provided with a first sheet stacking portion 134 serving as a sheet stacking portion on which the printed sheets P can be stacked. The printed sheets P are sequentially stacked on a sheet stacking surface 134a of the first sheet stacking portion 134. The second space W2 is a space into which the sheet P is temporarily ejected for reversing the sheet P after the front surface is printed in a duplex printing mode. In the present embodiment, the second space W2 can also function as a space for stacking the printed sheets P on a portion different from the first sheet stacking portion 134. In such a case, the printed sheets P are sequentially stacked on the second sheet stacking portion 135 (the reverse tray). In the present embodiment, the in-body space W is provided with a blower 136 for cooling the sheets P stacked on the first sheet stacking portion 134, which is described in detail later.

With reference to FIG. 1, the image forming apparatus 1 includes the image forming device 115, a body feed tray 112, and a body feed tray 113 below the in-body space W (in the −Z direction). The image forming apparatus 1 includes the side projecting portion 116 on a lateral side of the in-body space W (in the −X direction and on the right side in FIG. 1). The image forming apparatus 1 includes a rear projecting portion 117 (see FIG. 2) on the rear side of the in-body space W (in the +Y direction and on the rear side in the direction perpendicular to the plane on which FIG. 1 is illustrated). The image forming apparatus 1 includes the document feeder 110 and the document reading device 102 above the in-body space W. The image forming device 115 includes a writing device 103, imaging devices 104Y, 104M, 104C, and 104K, an intermediate transfer belt 178, a secondary transfer roller 189, and a fixing device 120. The image forming apparatus 1 includes an operation display panel 149 that functions as an operation display on an exterior of the image forming apparatus 1 to display various kinds of information about the image forming apparatus 1 and input various kinds of commands. A side on which an operator such as a user operates the operation display panel 149 or views a display while facing the operation display panel 149 is a front side (near side) of the image forming apparatus 1. Accordingly, the front side and the left side of the in-body space W are open when viewed from the front of the image forming apparatus 1.

A description is given below of an image forming operation (printing operation) in the image forming apparatus 1, with reference to FIG. 1. With reference to FIG. 1, multiple pairs of sheet conveying rollers disposed in the document feeder 110 feed an original document D from a document loading table and convey (feed) the original document D in a direction indicated by the dashed arrow in FIG. 1. By so doing, the original document D passes over the document reading device 102. At this time, the document reading device 102 optically reads image data of the original document D while the original document D is passing over the document reading device 102. The image data optically scanned by the document reading device 102 is converted into electrical signals. The electrical signals are then transmitted to the writing device 103. The writing device 103 emits laser beams for different colors onto photoconductor drums 105Y, 105M, 105C, and 105K based on the electrical signals of the image data, to perform an exposing process. In the image forming apparatus 1, a charging process, the exposing process, and a developing process are sequentially executed on the photoconductor drums 105Y, 105M, 105C, and 105K of the respective image devices 104Y, 104M, 104C, and 104K to form desired images on the photoconductor drums 105Y, 105M, 105C, and 105K, respectively. The images formed on the photoconductor drums 105Y, 105M, 105C, and 105K are transferred and superimposed onto the intermediate transfer belt 178 to form a color image. The color image formed on the intermediate transfer belt 178 is further transferred onto the surface of the sheet P fed and conveyed by a feed roller 197 from either of the body feed tray 112 and the body feed tray 113 to a sheet feed passage K0, at the position at which the intermediate transfer belt 178 faces the secondary transfer roller 189 (a secondary transfer nip). After the color image is transferred onto the surface of the sheet P, the sheet Pis conveyed to the position of the fixing device 120. The fixing device 120 fixes the transferred color image on the surface of the sheet P, to the sheet P (a fixing process). The sheets P on which an image has been formed by the image forming device 115 (printed sheets P) are ejected by a first ejection roller pair 131 from a first sheet ejection port H1 (sheet ejection port) via a first sheet ejection passage K1 (sheet ejection passage) of the side projecting portion 116 and are stacked on the first sheet stacking portion 134 (sheet stacking portion) in the first space W1.

When the “duplex printing mode” in which images are printed on both sides (front side and back side) of the sheet P is selected, the sheet P after the fixing process on the front side is guided to a second sheet ejection passage K2 (sheet relay passage) by the operation of a switching plate without being ejected from the image forming apparatus 1 as it is as in the case where above-described “single-sided printing mode” is selected. The sheet P guided to the second sheet ejection passage K2 is guided to a sheet reverse passage K3. At this time, with the rear end of the sheet P nipped by a second ejection roller pair 132 (reverse rollers), the sheet P is in a state where the other portion of the sheet Pis ejected from a second sheet ejection port H2 to the second space W2. Then, the sheet Pis switched back by the reverse rotation of the second ejection roller pair 132 and is conveyed toward a duplex conveyance passage K4. The sheet P guided to the duplex conveyance passage K4 is conveyed again toward the position of the secondary transfer nip (secondary transfer roller 189). An image is formed (printed) on the back side of the sheet P by the same image forming process (image forming operation) as described above at the position of the secondary transfer nip. Then, the sheet P is subjected to the fixing step in the fixing device 120, is ejected from the first sheet ejection port H1 to the first space W1 via the first sheet ejection passage K1, and is stacked on the first sheet stacking portion 134.

A configuration and operation of the image forming apparatus 1 according to the present embodiment is described in detail below. As described above with reference to FIGS. 1 and 2, the image forming apparatus 1 includes the image forming device 115, the side projecting portion 116, the rear projecting portion 117, the first sheet stacking portion 134 as a sheet stacking portion, the second sheet stacking portion 135 (reverse tray), and the blower 136.

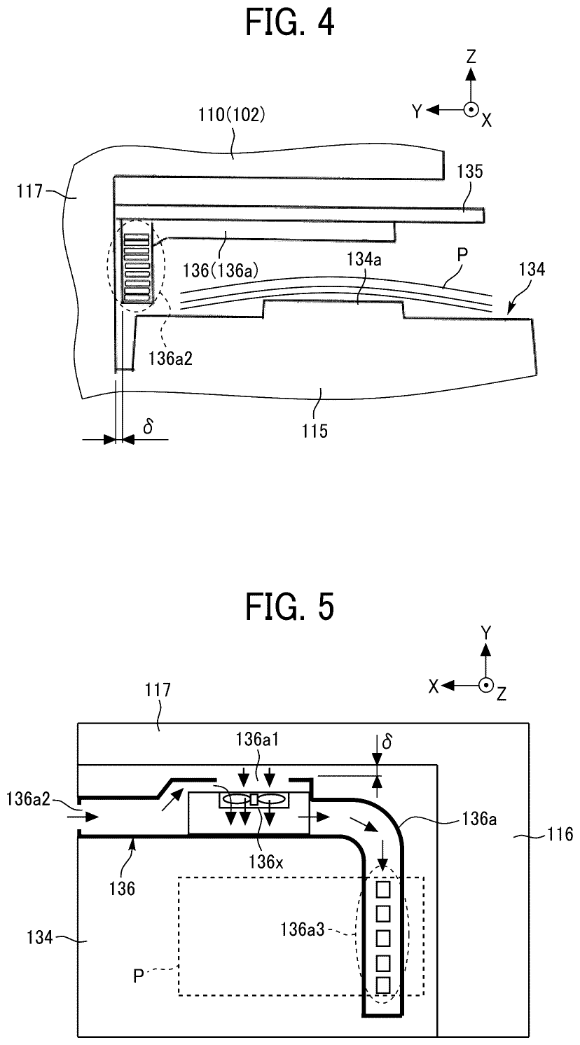

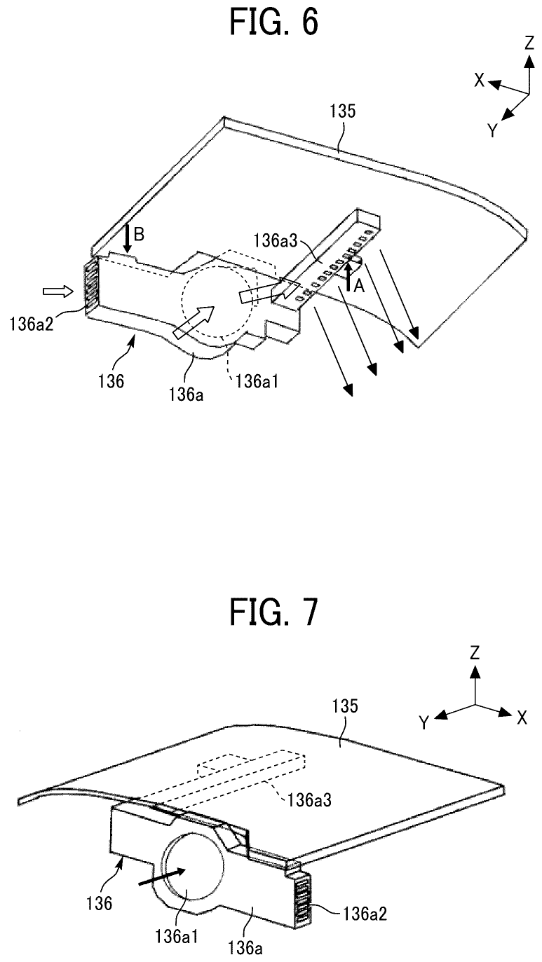

The image forming device 115 forms an image on the sheet P. The first sheet stacking portion 134 as a sheet stacking portion is disposed above the image forming device 115 and is capable of stacking the sheets P on which images have been formed by the image forming device 115. In the present embodiment, the sheet stacking surface 134a of the first sheet stacking portion 134 has an inclined surface that is inclined upward from the upstream side toward the downstream side in the sheet ejection direction (+X direction). As illustrated in FIG. 4, the sheet stacking surface 134a has a convex shape such that the center portion in the width direction (+Y direction) is higher than both ends in the width direction. With reference to FIGS. 1 to 4, the second sheet stacking portion 135 (reverse tray) is surrounded by the side projecting portion 116 and the rear projecting portion 117 above the space W (first space W1) that functions as the first sheet stacking portion 134. With reference to also FIGS. 6 to 7, the second sheet stacking portion 135 in the present embodiment is a tray-shaped member whose side closer to the side projecting portion 116 is curved to form a curved surface.

With reference to FIGS. 1 to 5, the side projecting portion 116 is disposed to protrude upward from a lateral end (the −X direction, which is the right end in FIG. 1) of the image forming device 115 (or the image forming apparatus 1) and to be adjacent to the first sheet stacking portion 134 (and the second sheet stacking portion 135). The side projecting portion 116 is provided with the first sheet ejection passage K1 as a sheet ejection passage, the first sheet ejection port H1 as a sheet ejection port, the second sheet ejection passage K2, and the second sheet ejection port H2. After an image is formed on a sheet P in the image forming device 115, the sheet P can be conveyed to the first sheet ejection passage K1 and ejected toward the first sheet stacking portion 134 through the first sheet ejection port H1. Alternatively, after an image is formed on a sheet P in the image forming device 115, the sheet P can be conveyed to the second sheet ejection passage K2 and ejected toward the second sheet stacking portion 135 through the second sheet ejection port H2. The positional relation between the image forming device 115 and the side projecting portion 116 may be a positional relation in which the image forming device 115 and the side projecting portion 116 overlap each other at least partially in the vertical direction on one end (lateral end) in the width direction (in the X direction, i.e., the left-and-right direction in FIG. 1) of the image forming apparatus 1. The positional relation between the image forming device 115 and the side projecting portion 116 may be a positional relation in which the image forming device 115 and the side projecting portion 116 are arranged side by side in the width direction of the image forming apparatus 1. The rear projecting portion 117 is disposed to protrude upward from the rear end (+Y direction) of the image forming device 115 (or the image forming apparatus 1) and to be adjacent to the first sheet stacking portion 134 (and the second sheet stacking portion 135). The rear projecting portion 117 forms the in-body space W functioning as the first sheet stacking portion 134 (and the second sheet stacking portion 135) together with the image forming device 115 and the side projecting portion 116. The positional relation between the image forming device 115 and the rear projecting portion 117 may be a positional relation in which the image forming device 115 and the side projecting portion 116 overlap each other at least partially in the vertical direction on the rear end in the depth direction (+Y direction, i.e., the direction perpendicular to the plane on which FIG. 1 is illustrated) of the image forming apparatus 1. Further, the positional relation between the image forming device 115 and the side projecting portion 116 may be a positional relation in which the image forming device 115 and the side projecting portion 116 are arranged side by side in the depth direction of the image forming apparatus 1.

With reference to FIGS. 4 and 5, the blower 136 is disposed in the in-body space W (the space in the body) to face the rear projecting portion 117 on the front side (−Y direction) with respect to the rear projecting portion 117. The blower 136 exhausts air taken in from the side facing the rear projecting portion 117 toward the sheets P (e.g., the sheets P being ejected or the sheets P stacked on the first sheet stacking portion 134) ejected from the first sheet ejection port H1 (sheet discharge port) toward the first sheet stacking portion 134 (sheet stacking portion). Specifically, as illustrated in FIG. 5, the blower 136 includes a first air-intake port 136a1 and an air-intake fan 136x on the rear side (+Y direction) away from the front side (−Y direction) that is the front side for a user. The first air-intake port 136a1 and the air-intake fan 136x take in air from the side on which the rear projecting portion 117 is disposed.

Specifically, the air-intake fan 136x and the first air-intake port 136a1 (air-intake port) of the blower 136 are disposed frontward (−Y direction) from the rear projecting portion 117 and rearward (+Y direction) from the sheets P stacked on the first sheet stacking portion 134. Specifically, the blower 136 is screwed (fixed) to the second sheet stacking portion 135 at positions A and B (see FIGS. 3 and 6). With reference to FIGS. 6 and 7, the blower 136 is disposed below (in the −Z direction) and on the rear side (in the +Y direction) of the second sheet stacking portion 135 (reverse tray) and united with the second sheet stacking portion 135, and exhausts air from above toward the sheet P ejected from the first sheet ejection port H1 toward the first sheet stacking portion 134 (and the sheet P on the first sheet stacking portion 134).

The blower 136 is disposed in the image forming apparatus 1 in this way so that the sheets P ejected and stacked on the first sheet stacking portion 134 are cooled. Thus, a failure that a toner image on the sheets P becomes a binding agent and the sheets P stacked on the first sheet stacking portion 134 stick to each other is less likely to occur compared to a case where the air blowing unit is not disposed in the image forming apparatus 1. The blower 136 in the present embodiment is formed to take in air typically from the rear side of the image forming apparatus 1 (i.e., the air-intake fan 136x and the first air-intake port 136a1 are disposed on the rear side). Thus, an inconvenience that a user carelessly touches the air-intake fan 136x and an inconvenience that the user feels the operation sound of the air-intake fan 136x as noise are less likely to occur. In particular, in the present embodiment, the blower 136 is disposed on the front side of the rear projecting portion 117 and on the rear side in the in-body space W so that a user is even less likely to access the air-intake fan 136x, and the operation sound of the air-intake fan 136x is less likely to reach the front side of the image forming apparatus 1 that is the position where the user stands. In the present embodiment, the air-intake fan 136x is disposed in the vicinity of the first air-intake port 136a1, so that the air-intake rate (air-intake amount) is high (large). Thus, the cooling effect on the sheet P can be enhanced.

More specifically, with reference to FIGS. 3 to 7, the blower 136 includes a duct 136a, the first air-intake port 136a1, a second air-intake port 136a2, the air-intake fan 136x, and an exhaust port 136a3. The duct 136a has the first air-intake port 136a1, the second air-intake port 136a2, and the exhaust port 136a3. The first air-intake port 136a1 is a typical air-intake port that opens at a position facing the rear projecting portion 117 with a clearance δ (see FIGS. 4 and 5) and takes air into the duct 136a through the clearance δ. In the present embodiment, the first air-intake port 136a1 is opened in a circular shape of a diameter substantially equal to the fan diameter of the air-intake fan 136x, and faces the vertical wall of the rear projecting portion 117 with the clearance δ. The second air-intake port 136a2 is a sub air-intake port that opens toward the lateral side (+X direction) opposite the side where the side projecting portion 116 is disposed in the in-body space W (first space W1) and takes air into the duct 136a. In the present embodiment, as illustrated in FIGS. 4 and 5, the second air-intake port 136a2 is a plurality of slits that open in a plane parallel to the lateral surface (lateral surface of the body cover on the right side) of the body of the image forming apparatus 1 and prevents a user from inserting his or her finger by mistake. The air-intake fan 136x is disposed to face the first air-intake port 136a1 on the front side (−Y direction). The air-intake fan 136x is a fan that takes in air from the first air-intake port 136a1 and the second air-intake port 136a2, and is disposed inside the duct 136a or positioned between a plurality of ducts 136a. The exhaust port 136a3 is an opening for exhausting the air taken in by the air-intake fan 136x, via the duct 136a. A portion of the duct 136a where the exhaust port 136a3 is formed is formed to extend from the rear side (+Y direction) to the front side (−Y direction) below the second sheet stacking portion 135 (reverse tray). The plurality of exhaust ports 136a3 are formed at intervals in the width direction (the up-and-down direction in FIG. 5) in order to cool the sheet P over the width direction. In the blower 136 as described above, air taken in from the outside flows in the direction indicated by arrows in FIG. 5 in the duct 136a, and is finally exhausted from the exhaust port 136a3 in the direction indicated by arrows in FIG. 6.

In the present embodiment, the clearance δ between the first air-intake port 136a1 and the rear projecting portion 117 (the clearance in the ±Y direction) described above is preferably set to 2 mm or more. Further, it is more preferable that the clearance δ is set to about 2 to 10 mm. This is because the inventor of the present disclosure has found that, as a result of experiments for confirming the relation between the size of the clearance δ and the cooling capability for the sheet P, the cooling capability for the sheet Pis gradually exhibited when the clearance δ is 1. 5 mm or more, and the cooling capability for the sheet Pis sufficiently exhibited when the clearance δ is 2 mm or more. Note that, if the clearance δ exceeds the 10 mm, the operation sound of the air-intake fan 136x gradually leaks to the outside, and thus, the upper limit of the clearance δ is more preferably set to 10 mm.

In the blower 136 according to the present embodiment, the air-intake amount from the first air-intake port 136a1 is larger than the air-intake amount from the second air-intake port 136a2. The first air-intake port 136a1 is disposed in the vicinity of the air-intake fan 136x, so that it is possible to maintain an air-intake amount larger than the intake air-intake amount of the second air-intake port 136a2 located at a position away from the air-intake fan 136x. The second air-intake port 136a2 is located at a position sufficiently away from the sheet P (the sheet P heated by the fixing device 120) on the first sheet stacking portion 134 and at a position where the outside air of the image forming apparatus 1 can be sufficiently taken in. Thus, the outside air having a relatively low temperature is easily taken in. The first air-intake port 136a1 is located downstream from the second air-intake port 136a2 in the flow direction of the intake air. Accordingly, the air taken in from the first air-intake port 136a1 is cooled by the air taken in from the second air-intake 136a2 in the duct 136a. The temperature of the air exhausted from the exhaust port 136a3 is lowered as compared with the case where air is taken in only from the first air-intake port 136a1, and thus the cooling capability for the sheet Pis enhanced. In the present embodiment, both the first air-intake port 136a1 and the second air-intake port 136a2 are disposed at positions that are not directly above the sheets P stacked on the first sheet stacking portion 134. Accordingly, even when heat of the sheet P rises, an inconvenience that a part or all of the hot air is taken in is reduced compared to the case where the first air-intake port 136a1 and the second air-intake port 136a2 are disposed directly above the sheet P.

With reference to FIG. 3, in the blower 136 according to the present embodiment, it is preferable that the positions of the first air-intake port 136a1 and the air-intake fan 136x in the sheet ejection direction (+X direction) substantially coincide with the position of the inclined surface of the sheet stacking surface 134a as illustrated in FIG. 3. With such an arrangement, the first air-intake port 136a1 and the air-intake fan 136x can be increased in size in terms of layout by the size of the inclined surface inclined downward in the sheet stacking surface 134a, and thus the cooling capability of the blower 136 can be enhanced.

In the present embodiment, the second sheet stacking portion 135 (which is screwed to be united with the blower 136) is not tightly fixed to the body of the image forming apparatus 1 by screwing, but is relatively loosely fixed (semi-fixed) by a way other than screwing. Specifically, the second sheet stacking portion 135 can be removably held by the side projecting portion 116 and the rear projecting portion 117 in a state where an insertion portion is inserted into an inserted portion formed in at least one of the side projecting portion 116 and the rear projecting portion 117, with portions R1 and R2 surrounded by dashed lines in FIG. 3 as the fixing positions. With such a configuration, as compared with a case where the second sheet stacking portion 135 is tightly fixed to the body of the image forming apparatus 1, vibration during operation of the blower 136 (the air-intake fan 136x) is less likely to be transmitted to the body of the image forming apparatus 1 via the second sheet stacking portion 135. As a result, an inconvenience that an abnormal image such as banding due to the vibration of the image forming device 115 occurs is also reduced.

With reference to FIG. 3, in the image forming apparatus 1 according to the present embodiment, a sheet detection sensor 133 as a detector that detects the sheet P passing through the vicinity of the first sheet ejection port H1 (sheet ejection port) is disposed in the side projecting portion 116. The sheet detection sensor 133 (detector) is a reflective photosensor that optically detects whether the sheet P is at the position. When a plurality of sheets P are continuously ejected from the first sheet ejection port H1, the air-intake fan 136x is controlled to start operating after a first specified time T1 has elapsed from the time when the leading end of the first sheet P is detected by the sheet detection sensor 133 (detector) and to stop operating after a second specified time T2 has elapsed from the time when the trailing end of the first sheet P is detected by the sheet detection sensor 133. Controlling the air-intake fan 136x in this way allows the apparatus to achieve more energy-saving than in a case where the air-intake fan 136x is constantly operating. In the present embodiment, the first specified time T1 and the second specified time T2 are both set to zero second, but the first specified time T1 and the second specified time T2 may be set to other times.

As described above, the image forming apparatus 1 according to the present embodiment includes the image forming device 115 that forms an image on the sheet P. The first sheet stacking portion 134 (sheet stacking portion) that can stack the sheets P on which images have been formed by the image forming device 115 is disposed above the image forming device 115. The side projecting portion 116 includes the first sheet ejection passage K1 (sheet ejection passage) and the first sheet ejection port H1 (sheet ejection port). After an image is formed on a sheet P in the image forming device 115, the sheet Pis conveyed through the first sheet ejection passage Kl and ejected toward the first sheet stacking portion 134 through the first sheet ejection port H1. The side projecting portion 116 is disposed to protrude upward from the lateral end of the image forming device 115 and to be adjacent to the first sheet stacking portion 134. The rear projecting portion 117 forms the space W together with the image forming device 115 and the side projecting portion 116 and is disposed to protrude upward from the rear end of the image forming device 115 and to be adjacent to the first sheet stacking portion 134. The blower 136 is disposed in the space W to face the rear projecting portion 117 on the front side with respect to the rear projecting portion 117. The blower 136 exhausts the air taken in from the side facing the rear projecting portion 117 toward the sheet P ejected from the first sheet ejection port H1 toward the first sheet stacking portion 134. With such a configuration, an inconvenience that a user accidentally touches the air-intake fan 136x or the user feels the operation sound of the air-intake fan 136x as noise is less likely to occur.

Note that embodiments of the present disclosure are not limited to the above-described embodiments and it is apparent that the above-described embodiments can be appropriately modified within the scope of the technical idea of the present embodiment in addition to what is suggested in the above-described embodiments. Further, features of components of the embodiments, such as the number, the position, and the shape are not limited the embodiments and thus may be preferably set.

In the specification of the present application, directions (sides) and surfaces such as “rear side,” “lateral side,” “front side,” and “back surface” are defined when a direction (side) in which an operator such as a user faces when performing a normal operation on an image forming apparatus is defined as “front side” or “front surface”.

Aspects of the present disclosure may be, for example, combinations of first to twelfth aspects as follows.

### First Aspect

An image forming apparatus (e.g., the image forming apparatus 1) includes an image forming device (e.g., the image forming device 115), a sheet stacking portion (e.g., the first sheet stacking portion 134), a side projecting portion (e.g., the side projecting portion 116), a rear projecting portion (e.g., the rear projecting portion 117), and a blower (e.g., the blower 136). The image forming device forms an image on a sheet (e.g., the sheet P). The sheet stacking portion is disposed above the image forming device and can stack the sheet on which the image has been formed in the image forming device. The side projecting portion includes a sheet ejection passage (e.g., the first sheet ejection passage K1) and a sheet ejection port (e.g., the first sheet ejection port H1). The sheet ejection passage is disposed to protrude upward from a lateral end of the image forming device and conveys the sheet on which the image has been formed in the image forming device. The sheet is ejected toward the sheet stacking portion through the sheet ejection port. The rear projecting portion is disposed to protrude upward from a rear end of the image forming device and to be adjacent to the sheet stacking portion, and forms a space (e.g., the space W) together with the side projecting portion. The blower is disposed in the space to face the rear projecting portion on a front side of the rear projecting portion and to exhaust air taken in from a side facing the rear projecting portion from the sheet ejection port toward the sheet to be ejected toward the sheet stacking portion.

### Second Aspect

The image forming apparatus (e.g., the image forming apparatus 1) according to the first aspect further includes a second sheet stacking portion (e.g., the second sheet stacking portion 135) disposed on an upper portion of the space (e.g., the space W). The side projecting portion (e.g., the side projecting portion 116) includes a second sheet ejection passage (e.g., the second sheet ejection passage K2) and a second sheet ejection port (e.g., the second sheet ejection port H2). The sheet (e.g., the sheet P) on which the image has been formed in the image forming device (e.g., the image forming device 115) can be conveyed through the second sheet ejection passage and ejected from the second sheet ejection port toward the second sheet stacking portion. The blower (e.g., the blower 136) is disposed in the second sheet stacking portion and exhausts air from the sheet ejection port (e.g., the first sheet ejection port H1) toward the sheet stacking portion (e.g., the first sheet stacking portion 134).

### Third Aspect

In the image forming apparatus (e.g., the image forming apparatus 1) according to the second aspect, the second sheet stacking portion (e.g., the second sheet stacking portion 135) is removably held by the side projecting portion (e.g., the side projecting portion 116) and the rear projecting portion (e.g., the rear projecting portion 117) in a state where an insertion portion of the second sheet stacking portion is inserted into an inserted portion formed in at least one of the side projecting portion and the rear projecting portion.

### Fourth Aspect

In the image forming apparatus (e.g., the image forming apparatus 1) according to any one of the first to third aspects, the blower (e.g., the blower 136) includes a duct (e.g., the duct 136a), a first air-intake port (e.g., the first air-intake port 136a1), a second air-intake port (e.g., the second air-intake port 136a2), an air-intake fan (e.g., the air-intake fan 136x), and an exhaust port (e.g., the exhaust port 136a3). The first air-intake port opens at a position facing the rear projecting portion (e.g., the rear projecting portion 117) with a clearance (e.g., the clearance δ). The second air-intake port opens toward a lateral side opposite a side where the side projecting portion 116 is disposed in the space (e.g., the space W) and takes air into the duct. The air-intake fan is disposed to face the first air-intake port and takes in air from the first air-intake port and the second air-intake port. The exhaust port exhausts air taken in by the air-intake fan through the duct.

### Fifth Aspect

In the image forming apparatus (e.g., the image forming apparatus 1) according to the fourth aspect, the clearance (e.g., the clearance δ) is 2 mm or more.

### Sixth Aspect

In the image forming apparatus (e.g., the image forming apparatus 1) according to the fourth or fifth aspect, the second air-intake port (e.g., the second air-intake port 136a2) has a plurality of slits that open in a plane parallel to a lateral surface of a body of the image forming apparatus.

### Seventh Aspect

In the image forming apparatus (e.g., the image forming apparatus 1) according to the fourth or fifth aspect, a plurality of exhaust ports including the exhaust port (e.g., the exhaust port 136a3) are arranged at intervals in a width direction of the sheet (e.g., the sheet P).

### Eighth Aspect

In the image forming apparatus (e.g., the image forming apparatus 1) according to any one of the fourth to seventh aspects, an air-intake amount taken in from the first air-intake port (e.g., the first air-intake port 136a1) is larger than an air-intake amount taken in from the second air-intake port (e.g., the second air-intake port 136a2).

### Ninth Aspect

In the image forming apparatus (e.g., the image forming apparatus 1) according to any one of the fourth to eighth aspects, the first air-intake port (e.g., the first air-intake port 136a1) is positioned downstream from the second air-intake port (e.g., the second air-intake port 136a2) in a flow direction of the air taken in.

### Tenth Aspect

In the image forming apparatus (e.g., the image forming apparatus 1) according to any one of the fourth to ninth aspects, a sheet stacking surface (e.g., the sheet stacking surface 134a) of the sheet stacking portion (e.g., the first sheet stacking portion 134) includes an inclined surface that is inclined upward from an upstream side to a downstream side in a sheet ejection direction. Positions of the first air-intake port (e.g., the first air-intake port 136a1) and the air-intake fan (e.g., the air-intake fan 136x) in the sheet ejection direction substantially coincide with a position of the inclined surface.

### Eleventh Aspect

In the image forming apparatus (e.g., the image forming apparatus 1) according to any one of the fourth to tenth aspects, both the first air-intake port (e.g., the first air-intake port 136a1) and the second air-intake port (e.g., the second air-intake port 136a2) are disposed at positions rearward from sheets (e.g., the sheet P) stacked on the sheet stacking portion (e.g., the first sheet stacking portion 134).

### Twelfth Aspect

In the image forming apparatus (e.g., the image forming apparatus 1) according to any one of the fourth to eleventh aspects, the side projecting portion (e.g., the side projecting portion 116) includes a detector (e.g., the sheet detection sensor 133) to detect whether a sheet (e.g., the sheet P) has passed through the vicinity of the sheet ejection port (e.g., the first sheet ejection port H1). When a plurality of sheets are continuously ejected from the sheet ejection port, the air-intake fan (e.g., the air-intake fan 136x) starts operating after a first specified time (e.g., the first specified time T1) elapses from detection of a leading end of a first sheet by the detector and stops operating after a second specified time (e.g., the second specified time T2) elapses from detection of a trailing end of a last sheet by the detector.

### Thirteenth Aspect

In the image forming apparatus (e.g., the image forming apparatus 1) according to any one of the fourth to twelfth aspects, the air-intake port (e.g., the first air-intake port 136a1) and the air-intake fan (e.g., the air-intake fan 136x) disposed in the blower (e.g., the blower 136) are arranged on a front side of the rear projecting portion (e.g., the rear projecting portion 117) and on a rear side of sheets (e.g., the sheet P) stacked on the sheet stacking portion (e.g., the first sheet stacking portion 134).

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

1. An image forming apparatus comprising:
an image forming device to form an image on a sheet;
a sheet stacking portion disposed above the image forming device to stack the sheet on which the image has been formed by the image forming device;
a side projecting portion protruding upward from a lateral end of the image forming device and being adjacent to the sheet stacking portion, the side projecting portion including:
a sheet ejection passage to convey the sheet on which the image has been formed by the image forming device; and
a sheet ejection port to eject the sheet toward the sheet stacking portion;
a rear projecting portion protruding upward from a rear end of the image forming device and being adjacent to the sheet stacking portion to form a space together with the side projecting portion; and
a blower disposed in the space and facing the rear projecting portion on a front side of the rear projecting portion, to take in air from a side facing the rear projecting portion and exhaust the air from the sheet ejection port toward the sheet ejected toward the sheet stacking portion.

2. The image forming apparatus according to claim 1, further comprising another sheet stacking portion disposed on an upper area of the space,
wherein the side projecting portion includes:
another sheet ejection passage to convey the sheet on which the image has been formed by the image forming device; and
another sheet ejection port to eject the sheet toward said another sheet stacking portion, and
wherein the blower is disposed on said another sheet stacking portion to exhaust air from the sheet ejection port toward the sheet ejected toward the sheet stacking portion.

3. The image forming apparatus according to claim 1,
wherein said another sheet stacking portion is removably held by the side projecting portion and the rear projecting portion in a state where an insertion portion of said another sheet stacking portion is inserted into an inserted portion formed in at least one of the side projecting portion and the rear projecting portion.

4. The image forming apparatus according to claim 1,
wherein the blower includes:
a duct;
a first air-intake port that opens at a position facing the rear projecting portion with a clearance;
a second air-intake port that opens toward a lateral side opposite a side where the side projecting portion is disposed in the space, to take air into the duct;
an air-intake fan facing the first air-intake port to take in air from the first air-intake port and the second air-intake port; and
an exhaust port to exhaust, through the duct, the air taken in by the air-intake fan.

5. The image forming apparatus according to claim 4,
wherein the clearance is 2 mm or more.

6. The image forming apparatus according to claim 4,
wherein the second air-intake port has a plurality of slits that open in a plane parallel to a lateral surface of a body of the image forming apparatus.

7. The image forming apparatus according to claim 4, wherein a plurality of exhaust ports including the exhaust port are arranged at intervals in a width direction of the sheet.

8. The image forming apparatus according to claim 4,
wherein an air-intake amount taken in from the first air-intake port is greater than an air-intake amount taken in from the second air-intake port.

9. The image forming apparatus according to claim 8,
wherein the first air-intake port is at a position downstream from the second air-intake port in a flow direction of the air taken in.

10. The image forming apparatus according to claim 4,
wherein a sheet stacking surface of the sheet stacking portion includes an inclined surface that is inclined upward from an upstream side to a downstream side in a sheet ejection direction, and
wherein positions of the first air-intake port and the air-intake fan in the sheet ejection direction substantially coincide with a position of the inclined surface.

11. The image forming apparatus according to claim 4,
wherein both the first air-intake port and the second air-intake port are at positions rearward from the sheet stacked on the sheet stacking portion.

12. The image forming apparatus according to claim 4,
wherein the side projecting portion includes a detector to detect whether the sheet passes a vicinity of the sheet ejection port, and
wherein, when a plurality of sheets are continuously ejected from the sheet ejection port, the air-intake fan starts operating after a first specified time elapses from detection of a leading end of a first sheet by the detector and stops operating after a second specified time elapses from detection of a trailing end of a last sheet by the detector.

13. The image forming apparatus according to claim 1,
wherein the air-intake port and the air-intake fan of the blower are at positions forward from the rear projecting portion and rearward from the sheet stacked on the sheet stacking portion.
